(19) United States
(12) Patent Application Publication
(10) Pub. No.: US 2025/0043212 A1
(43) Pub. Date: Feb. 6, 2025

(54) Granular Additive

(71) Applicant: Reckitt Benckiser Finish B.V., Hoofddorp (NL)

(72) Inventors: Alias Younis Al-Bayati, Heidelberg (DE); Torsten Roth, Heidelberg (DE)

(21) Appl. No.: 18/717,773

(22) PCT Filed: Dec. 8, 2022
(86) PCT No.: PCT/EP22/85073

§ 371 Date: Jun. 7, 2024

(30) Foreign Application Priority Data
Dec. 9, 2021 (GB) 2117816.5

(51) Int. Cl. C11D 3/00; C11D 3/20; C11D 3/33; C11D 3/37; C11D 17/06

(52) U.S. Cl. CPC C11D 3/0073; C11D 3/2086; C11D 3/33; C11D 3/3726; C11D 17/06; C11D 2111/18

(57) ABSTRACT

The present invention relates to a granular additive composition. In particular, the invention relates to a granular additive composition comprising at least one builder and at least one cationic polymer. The composition provides an improved delivery of consumer-related benefits, in particular glass protection, compared to compositions comprising conventional detergent compositions.

### TECHNICAL FIELD OF THE INVENTION

The present invention relates to additives for detergent compositions. In particular, the invention relates to a granular additive comprising a builder and a cationic polymer which provides consumer-relevant benefits, in particular glass protection. The invention further relates to methods of preventing glass corrosion in an automatic dishwasher washing cycle, and to uses of the granular additive.

### BACKGROUND TO THE INVENTION

Many kitchenware products are commonly made of glass, for example, drinking cups and vessels, baking dishes, mixing bowls and airtight containers. A typical automatic dishwashing cycle is carried out at temperatures of between 4° and 70° C. and at alkali pH (typically greater than pH 8.5, and often exceeding pH 10). In these conditions, glass is susceptible to corrosion. Corrosion of glass may occur due to hydrolytic dissolution of the silicon dioxide network which forms the glass. Hydrolytic dissolution causes glass components to be released into the wash liquor and/or are incorporated into alteration products (amorphous and crystalline phases) on the reacting glass surface. Noticeable effects of glass corrosion include glass having a cloudy or an etched appearance after frequent washing. The cloudy and etched appearance of a glass can be enhanced if a consumer lives in a hard-water area. By washing glass in hard-water, deposits, such as limescale, can temporarily cling to glass and cause the cloudy appearance.

Detergent products, for example automatic dishwashing products, typically comprise one or more active components which provide consumer-related benefits to goods washed in an automatic dishwasher. Such benefits include, for example, glass protection, antimicrobial activity and long-term shine in respect of glass and aluminium goods. Conventional active components include, for example, zinc salts, silicates or polyethylene imine polymers.

Typical polymer-based detergent products, such as automatic dishwashing products, comprise the active component in the form of an aqueous solution. Monodose automatic dishwashing products which combine aqueous active components and a detergent composition are known, for example a 2-in-1 solution comprising a chelating agent and an active component which provides some glass protection benefit. However, there are several problems associated with such products.

Supplying an aqueous solution comprising an active component into a detergent composition is detrimental to the stability of the ingredients comprised in the detergent composition. For example, the aqueous solution comprising the active component can dissolve solid components in the detergent composition, including solid cleaning actives and solid coatings of granular components comprising an active component, thereby reducing the efficacy of the cleaning actives and granular components.

Moreover, the aqueous solution may affect the stability of a water-soluble film packaging (for example, poly(vinyl alcohol) (PVOH) film) which contains the detergent composition. If the stability of the water-soluble film is compromised, the packaging may rupture, causing the detergent composition to leak out of the packaging and onto neighbouring packaged detergent compositions within a storage container, therefore rendering several products unusable. As such, there is an inherent incompatibility between supplying an aqueous solution comprising an active component and many conventional detergent compositions.

Further, active components in the form of aqueous solutions can lead to problems of ‘powder clumping’ when mixed with solid detergent compositions. The aqueous solutions can create compacted masses of solid detergent composition which greatly affects the efficacy and distribution of the detergent composition during a wash cycle.

Moreover, problems exist in relation to manufacturing a detergent composition comprising an active component. Conventionally, the current dosage level of an active component is between about 5 and about 100 mg/wash. For example, a conventional detergent composition comprising a zinc salt active component comprises between 10 and 100 mg/wash of the zinc salt, and a conventional detergent composition comprising a polyethylene imine active component comprises between 5 and 50 mg/wash of the polyethylene imine. Disadvantageously, during manufacture, this low dosage level of active component in an aqueous solution poses a risk of uneven distribution of the active component across individual products, often resulting in the final consumer product not delivering the claimed performance benefits associated with the active component. Further, the uneven distribution across the final consumer product may mean that a higher than necessary amount of active component is used in manufacture, in an attempt to ensure satisfactory distribution of the active component. Critically, this increases the safety concerns associated with the detergent products, in particular hazard labelling and aquatic toxicity of the detergent composition due to the high concentration of the active component. It follows that a high concentration of an active component, in particular when the active component is a non-biodegradable polymer, results in a detergent product with a greater environmental impact, i.e. the product is less sustainable than similar products which use a lower concentration of the active component.

In addition, a low dosage level may require the preparation and use of a pre-mix composition comprising the active component in a solvent. Disadvantageously, preparation of a pre-mix adds to the complexity and cost of manufacture. Moreover, components of the pre-mix may, undesirably, react with the solvent comprising the active component, therefore, reducing the effectiveness of the active component. As such, extensive research must be undertaken to identify suitable solvents which do not yield undesirable side-reactions; this is both costly and time-consuming to the manufacturer.

Solid compositions in powder or granular form comprising an active component are known, see for example, WO2012/168739, which describes builder granules comprising methyl glycine diacetic acid (MGDA) and a disilicate. In addition, EP2989192 describes formulations comprising an aminocarboxylate builder (for example, MGDA) and an alkoxylated alkylene imine polymer. Such formulations exhibit considerable drawbacks in respect of stability, handling and activity, in particular activity of the active component in the final consumer product. Moreover, conventional formulations comprising an aminocarboxylate builder (for example, MGDA) and an alkoxylated alkylene imine polymer or a simple, unmodified alkylene imine polymer (for example, a poly(ethylene imine)) active component undergo degradation/oxidation of the alkoxylated alkylene imine polymer or unmodified alkylene imine polymer by oxidising agents also comprised in the detergent formulation. Such degradation/oxidation of the imine polymer results in significantly reduced function and, therefore, considerably reduced efficacy of the active component in the detergent formulation.

As previously stated, degradation/oxidisation of the abovementioned imine polymers occurs due to the presence of oxidising agents and, therefore, occurs independently of the presence of a builder, such as MGDA or silicates, in the detergent formulation.

The known products do not provide a reliable and effective delivery of benefits (for example, glass protection, antimicrobial activity and long-term shine in respect of glass and aluminium goods) and simultaneously ameliorate the above disadvantages associated with conventional detergent compositions.

It is an aim of embodiments of the invention to overcome or mitigate at least one problem of the prior art, whether expressly disclosed herein or not.

### SUMMARY OF THE INVENTION

According to a first aspect of the invention, there is provided a granular additive for a detergent composition, the additive comprising a builder and a cationic polymer, wherein the cationic polymer has a pH-independent permanent positive charge.

The granular additives are useful in any stage of a dishwashing cycle of an automatic dishwasher. In this specification the term “dishwashing cycle” means the entire dishwashing operation, including a main wash and a rinse stage a pre-wash, an intermediate stage, and any additional cleaning or rinsing stages.

The granular additives are not limited to automatic dishwashing applications and may find application in any industrial or domestic cleaning or treatment, including but not limited to, automatic dishwashing, hard surface cleaning, for example window cleaning and cleaning of an element made of glass, water treatment and laundry washing.

In this specification, the term ‘pH-independent permanent positive charge’ means that the cationic polymer has a positive charge irrespective of the pH of its solution.

Providing a granular additive comprising a builder and a cationic polymer, wherein the cationic polymer has a pH-independent permanent positive charge, advantageously provides a more reliable delivery of consumer-related benefits (for example, glass protection, antimicrobial activity and long-term shine in respect of glass and aluminium goods) when used in as a detergent composition, in particular in an automatic dishwasher, compared to conventional formulations comprising active components individually or in combination with a detergent composition. The inventive composition can be used either as an additional additive ingredient in state of the art detergent compositions, dishwasher detergents, additives or rinse aid, or used as a separate product or can be also applied once or more often in any step of a dishwashing washing cycle or laundry cycle, for example the inventive additive may be dosed in the pre-wash stage followed by addition of a state of the art detergent composition in the main wash cycle. The additive of the invention may also be released continuously during one or more stages of a dishwashing cycle or laundry cycle, for example, as a steady release from a slow dissolving source or from a gadget arranged to dose the additive continuously or at defined time intervals during one or more dishwashing cycle stages or laundry cycle stages.

Surprisingly, it has been found that a granular additive comprising a builder and a cationic polymer, wherein the cationic polymer has a pH-independent permanent positive charge, provides enhanced protection of glass, even at low dosage levels of the cationic polymer, for example from about 1 to about 5 mg/wash, in particular from about 1 to about 3 mg/wash, for example about 1.5 mg/wash, compared to a formulation comprising a combination of a builder, for example MGDA, glutamic acid N,N-diacetic acid (GLDA) or iminodisuccinic acid (IDS), and a polymer which does not have a pH-independent permanent positive charge, for example an alkoxylated alkyleneimine polymer. Beneficially, this means that components of kitchenware made of glass are significantly less susceptible to corrosion and, therefore, there is no, or at least substantially less, mass loss (i.e. the amount of glass (in mg) lost per wash cycle), clouding and etching of the glass components when washed using the granular additive of the invention compared to washing with conventional detergent compositions.

Further, by providing the granular additive of the invention, the inventive granular additive improves processability of manufacture due to significantly reduced powder clumping of powdered detergent components owing to the absence of an aqueous solution comprising an active component. Moreover, the inventive granular additive does not require the use of a pre-mix comprising a solvent and an active component, i.e. the cationic polymer which has a pH-independent permanent positive charge, therefore, the inventive composition significantly, if not completely, reduces the number of undesired reactions with other detergent components which may be present during manufacture.

Advantageously, providing the inventive additive in granular form reduces the amount of active component, i.e. the cationic polymer which has a pH-independent permanent positive charge, required to manufacture a detergent composition. This is because the granular form of the inventive additive allows for a more homogenous distribution of the cationic polymer across individual products, therefore, ensuring that the final consumer product delivers the claimed performance benefits associated with the active component.

Further advantageously, by providing an active component in a granular additive, addition of the granular additive and, therefore, the active component, into a detergent composition is significantly less complex than conventional methods of delivery of an active component into a detergent composition.

Further, providing the inventive additive in granular form eliminates dust formation which is encountered when producing detergent compositions comprising fine powders. As such, the present invention is comparably safer and easier to handle than detergent compositions which rely on fine powders.

Moreover, the present invention is an improvement on the conventional detergent compositions which comprise an alkoxylated alkylene imine polymer as a satisfactory, but not a strongly convincing, glass protection agent. Moreover, the present invention is an improvement on the conventional detergent compositions which comprise MGDA and a disilicate. MGDA acts as a chelating agent in dishwashing detergent compositions and, therefore, contributes to the corrosion of glass. Such conventional detergent compositions therefore require a glass protection agent to ameliorate the corrosive effect of MGDA. However, known combinations of MGDA and a glass protection agent, for example a disilicate, do not produce the desired glass protection benefits.

Preferably, the granular additive comprises less than 3 wt. %, less than 2 wt. %, less than 1 wt. % or less than 0.5 wt. % polyethylene imine. In some embodiments the granular additive comprises no, or substantially no, polyethylene imine. Formulations comprising a polyethylene imine may exhibit considerable drawbacks in respect of stability, handling and activity, in particular activity of the active component in the final consumer product.

The cationic polymer may comprise at least one quaternary ammonium group. The at least one quaternary ammonium group is an ammonium cation that is permanently charged, independent of the pH of its solution. Surprisingly, it has been found that a cationic polymer having a pH-independent permanent positive charge comprising at least one quaternary ammonium group can provide various consumer-relevant benefits such as enhanced shine, material care and antimicrobial activity, in respect of kitchenware components, in particular glassware, when used in a dishwasher, in particular in an automatic dishwasher.

The at least one quaternary ammonium group may be selected from alkylammonium, dialkylammonium, trialkylammonium, iminium, amidinium, formamidinium, guanidinium and biguanidinium quaternary ammonium groups.

The alkvlammonium, dialkylammonium, trialkylammonium quaternary ammonium groups may comprise any linear or branched alkyl group. The alkyl group may be any C1 to C20, preferably C1 to C10, even more preferably C1 to C5, linear or branched alkyl group. Examples of suitable alkyl groups include, but are not limited to, methyl, ethyl, n-propyl, isopropyl, n-butyl, isobutyl, sec-butyl, tert-butyl, tert-amyl, pentyl, hexyl, heptyl and octyl. The alkyl group may be a substituted alkyl group.

The at least one quaternary ammonium group may comprise a group selected from an aryl group, a heteroaryl group, a cycloalkyl group, a heterocycloalkyl group, an alkoxy group, an aryloxy group, an alcohol group, a carboxylate ester group or an ether group.

The aryl group may comprise 5, 6, 7, 8, 9 or more carbon atoms. The aryl group may be substituted. Examples of aryl groups include, but are not limited to, 3-methylphenyl, 4-methylphenyl and dimethylphenyl.

The heteroaryl group may comprise 4, 5, 6, 7, 8, 9, or more than 9 atoms. The heteroaryl group may be substituted. Examples of heteroaryl groups include, but are not limited to, aromatic C3-C8 heterocyclic groups comprising one oxygen or sulphur atom or up to four nitrogen atoms, or a combination of one oxygen or sulphur atom and up to two nitrogen atoms, and their substituted as well as benzo- and pyrido-fused derivatives, for example, connected via one of the ring-forming carbon atoms. The heteroaryl group may be substituted with one or more substituents, independently selected from halo, hydroxy, amino, cyano, nitro, alkylamido, acyl, C1-C6-alkoxy, C1-C6-alkyl, C1-C6-hydroxyalkyl, C1-C6-aminoallcyl, alkylsulfenyl, alkylsulfinyl, alkylsulfonyl, sulfamoyl, or trifluoromethyl. Examples of heteroaryl groups include, but are not limited to, unsubstituted and mono- or di-substituted derivatives of furan, benzofuran, thiophene, benzothiophene, pyrrole, pyridine, pyrazole, pyrylium, imidazole, indole, oxazole, benzoxazole, isoxazole, benzisoxazole, thiazole, benzothiazole, isothiazole, imidazole, benzimidazole, pyrazole, indazole, tetrazole, quinoline, isoquinoline, pyridazine, pyrimidine, purine and pyrazine, 1,2,4-triazine, 1,3,5-triazine, furazan, 1,2,3-oxadiazole, 1,2,5-oxadiazole, 1,2,3-thiadiazole, 1,2,4-thiadiazole, 1,2,5-thiadiazole, 1,3,4-thiadiazole, thiophene, triazole, benzotriazole, pteridine, phenoxazole, oxadiazole, benzopyrazole, quinolizine, cinnoline, phthalazine, quinazoline, and quinoxaline.

The cycloalkyl group may be any C3 to C20, preferably C3 to C10, cycloalkyl group. The cycloalkyl group may be substituted. Examples of cycloalkyl groups include, but are not limited to, cyclopropane, cyclobutane, cyclopentane and cyclohexane.

The heterocycloalkyl group may comprise 4, 5, 6, 7, 8, 9, or more than 9 atoms. The heterocycloalkyl group may be substituted. Examples of heterocycloalkyl group include, but are not limited to, C3-C8 heterocyclic groups comprising one, two, three or more oxygen or sulphur atoms or up to four nitrogen atoms, or a combination of one, two, three or more oxygen or sulphur atoms and up to two nitrogen atoms, and their substituted as well as fused derivatives, for example, connected via one of the ring-forming carbon atoms. The heterocycloalkyl group may be substituted with one or more substituents, independently selected from halo, hydroxy, amino, cyano, nitro, alkylamido, acyl, C1-C6-alkoxy, C1-C6-alkyl, C1-C6-hydroxyalkyl, C1-C6-aminoallcyl, alkylsulfenyl, alkylsulfinyl, alkylsulfonyl, sulfamoyl, or trifluoromethyl. Examples of heterocycloalkyl groups include, but are not limited to, unsubstituted and mono- or di-substituted derivatives of pyrrolidine, pyrroline, pyrazolidine, imidazolidine, pyrazoline, imidazoline, tetrahydrofuran, 1,3-dioxolane, tetrahydrothiophene, 1,2-oxathiolane, 1,3-oxathiolane, sulpholane, 2,4-thiazolidinedione, succinimde, 2-oxazolidone, hydantoin, piperidine, piperazine, tetrahydropyran, 2H-pyran, 4H-pyran, 1,4-dioxane, 1,4-dioxine, thiane, 2H-thiopyran, 4H-thiopyran, 1,3-dithiane, 1,4-dithiane, 1,3,5-trithiane, morpholine, 4H-1,2-oxazine, 2H-1,2-oxazine, 6H-1,2-oxazine, 4H-1,3-oxazine, 2H-1,3-oxazine, 6H-1,3-oxazine, 4H-1,4-oxazine, 2H-1,4-oxazine, thiomorpholine, thiazine, 4H-1,4-thiazine, 2H-1,2-thiazine, 6H-1,2-thiazine, 2H-1,4-thiazine, cytosine, thymine, uracil, and thiomorpholine dioxide.

The alkoxy group may be any C1 to C10 alkoxy group, for example a methoxy or ethoxy group. The alkoxy group may be substituted.

The aryloxy group may comprise 5, 6, 7, 8, 9 or more carbon atoms. The aryloxy group may be substituted. The aryloxy group may be a phenoxy group.

The alcohol group may comprise any C1 to C20, preferably C1 to C10, more preferably C1 to C6 alcohol. The alcohol group may be substituted. The alcohol group may be any primary, secondary or tertiary alcohol group. The alcohol group may be any linear or branched alcohol group. The alcohol group may comprise more than one hydroxyl group, for example, two hydroxyl groups (diol) or three hydroxyl groups (triol).

The carboxylate ester group may be any carboxylate ester group of the formula:

R¹CO₂R²

wherein R¹ and R² comprise any alky or aryl group. The alkyl and/or aryl group may be substituted.

The term ‘substituted’ as used in this specification refers to a group in which one, or more than one, of the hydrogen atoms present have been replaced with one or more groups such as, but not limited to, alkyl, heteroalkyl, haloalkyl, heterohaloalkyl, cycloalkyl, aryl, arylalkyl, heteroaryl, non-aromatic heterocycle, hydroxy, alkoxy, aryloxy, mercapto, alkylthio, arylthio, cyano, halo, carbonyl, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, silyl, trihalomethanesulfonyl, and amino, including mono- and di-substituted amino groups. In embodiments in which two or more hydrogen atoms have been substituted, the substituent groups may be linked to form a ring.

The at least one quaternary ammonium group may have the formula:

—⁺N(R¹)(R²)—

wherein R¹ and R² are each independently selected from a hydrogen atom, an alkyl group, an aryl group, a heteroaryl group, a cycloalkyl group, a heterocycloalkyl group, an alkoxy group, an aryloxy group, an alcohol group, a carboxylate ester group and an ether group. R¹ and R² may be identical or different.

At least one of R¹ and R² may be a linear or branched C1 to C10 alkyl group, preferably a linear or branched C1 to C5 group. At least one of R¹ and R² may be a C1, C2 or C3 alkyl group.

R¹ and R² may each be a linear or branched C1 to C10 alkyl group, preferably a linear or branched C1 to C5 alkyl group. R¹ and R² may each be a C1, C2 or C3 alkyl group. R¹ and R² may each be a methyl group.

The degree of quaternization of the cationic polymer may be between about 1 and about 100 mol %, between about 10 and about 90 mol %, between about 20 and about 80 mol %, between about 30 and about 70 mol %, between about 40 and about 60 mol %, or about 50 mol %, based on quaternizable N-atoms in the cationic polymer.

The degree of quaternization of the cationic polymer may be up to about 10 mol %, up to about 20 mol %, up to about 30 mol %, up to about 40 mol %, up to about 50 mol %, up to about 60 mol %, up to about 70 mol %, up to about 80 mol %, up to about 90 mol %, or up to about 100 mol %, based on quaternizable N-atoms in the cationic polymer.

The cationic polymer may further comprise a urea group and/or a urethane group, or a derivative thereof, for example a thio-derivative such as thiourea. Each of the urea and/or urethane groups comprise at least one oxygen and at least one nitrogen atom. Advantageously, the oxygen and/or nitrogen atoms confer strong hydrogen-bonding properties to the cationic polymer which facilitates the efficacy of the cationic polymer in providing consumer-related benefits, i.e. glass protection and anti-microbial activity and long-term shine in respect of glass and aluminium goods.

The urea group and/or the urethane group may comprise at least one quaternized N-atom. Specifically, a urea group comprises two nitrogen atoms and none, one or both of these nitrogen atoms may be quaternized. Moreover, a urethane group comprises one nitrogen atom and this nitrogen atom may be quaternized.

Advantageously, a cationic polymer comprising a urea group and/or a urethane group allows for a greater mole percent of the cationic polymer to be quaternized, therefore, increasing the charge density of the polymer which facilitates the efficacy of the cationic polymer in providing consumer-related benefits, i.e. glass protection and anti-microbial activity and long-term shine in respect of glass and aluminium goods.

The cationic polymer may further comprise a pyrrolidine group. The pyrrolidine group may be substituted with one or more substituents, independently selected from halo, hydroxy, amino, cyano, nitro, alkylamido, acyl, C1-C6-alkoxy, C1-C6-alkyl, C1-C6-hydroxyalkyl, C1-C6-aminoallcyl, alkylsulfenyl, alkylsulfinyl, alkylsulfonyl, sulfamoyl, or trifluoromethyl. The cationic polymer may be a polydiallyldimethylammonium chloride (polyDADMAC or polyDDA) cationic polymer. Advantageously, polyDADMAC has a high permanent charge density of about 6.2 meq/g. As such, polyDADMAC can provide various consumer-relevant benefits such as enhanced shine, material care and antimicrobial activity, in respect of kitchenware components, in particular glassware, when used in a dishwasher, in particular in an automatic dishwasher, or in a detergent composition.

The cationic polymer may be obtained from renewable materials. The cationic polymer may be a biobased cationic polymer or a modified biopolymer.

The cationic polymer may be a polyurethane cationic polymer, a polyepoxide cationic polymer, a polyether cationic polymer or a polyester cationic polymer. The polyether cationic polymer may be a polyoxymethylene (POM) cationic polymer, polyethylene glycol (PEG) cationic polymer, polyethylene oxide (PEO) cationic polymer, polyoxyethylene (POE) cationic polymer, polytetramethylene glycol (PTMG) cationic polymer, polytetramethylene ether glycol (PTMEG) cationic polymer or polytetrahydrofuran (PTHF) cationic polymer.

The cationic polymer may be a homopolymer (for example, comprising repeat unit ‘A’, -A-A-A-A-A-A-), an alternating copolymer (for example, comprising repeat units ‘A’ and ‘B’, -A-B-A-B-A-B-A-), a random copolymer (for example, -A-B-B-B-A-B-A-B-A-A-), a block copolymer (for example, -A-A-A-B-B-B-), a graft copolymer (for example, -A-A-A(-B-B-B-)-A-A-A(-B-B-B-)-A-A-A-), a periodic copolymer (for example, A-B-A-B-B-A-A-A-A-B-B-B), a stereoblock copolymer or a gradient copolymer.

The cationic polymer may have a pH-independent permanent positive charge having a permanent charge density of at least about 1 meq/g, at least about 2 meq/g, at least about 3 meq/g, at least about 4 meq/g, at least about 5 meq/g, at least about 6 meq/g, at least about 7 meq/g, at least about 8 meq/g, at least about 9 meq/g, or at least about 10 meq/g. The cationic polymer may have a pH-independent permanent positive charge having a permanent charge density of between about 1 and about 10 meq/g, between about 2 and about 9 meq/g, between about 3 and about 8 meq/g, between about 4 and about 7 meq/g, between about 4 and about 6 meq/g, or about 5 meq/g. The cationic polymer may have a pH-independent permanent positive charge having a permanent charge density of between about 2.0 and about 9.0 meq/g, between about 2.5 and about 8.5 meq/g, between about 3.0 and about 8.0 meq/g, between about 3.5 and about 7.5 meq/g, between about 4.0 and about 7.0 meq/g, between about 4.5 and about 6.5 meq/g, between about 5.0 and about 6.0 meq/g, or between about 5.0 and about 5.5 meq/g.

The cationic polymer may be present in an amount between about 0.01 and about 5% wt., between about 0.02 and about 4.5% wt., between about 0.03 and about 4% wt., between about 0.04 and about 3.5% wt., between about 0.05 and about 3% wt., between about 0.06 and about 2.5% wt., between about 0.07 and about 2% wt., between about 0.08 and about 1.5% wt., between about 0.09 and about 1% wt., or between about 0.1 and about 0.5% wt., based on the weight of the granular additive composition, and the same may be released during the dishwashing cycle or stages thereof to which the granular additive composition is applied. The cationic polymer may be present in an amount between about 0.01 and about 3.0% wt., based on the weight of the granular additive composition, and the same may be released during a dishwashing cycle or stages thereof to which the granular additive is applied. Preferably, the cationic polymer is present in an amount about 0.1% wt., based on the weight of the granular additive composition. The cationic polymer may be present in an amount of no more than 0.01% wt., 0.02% wt., 0.03% wt., 0.04% wt., 0.05% wt., 0.06% wt., 0.07% wt., 0.08% wt, 0.09% wt, 0.1% wt, 0.2% wt, 0.3% wt, 0.4% wt., or no more than 0.5% wt., based on the weight of the granular additive composition, and the same may be released during a dishwashing cycle or stages thereof to which the granular additive composition is applied.

The cationic polymer may be present in an amount of between about 0.1 and about 5 mg/g of builder, between about 0.2 and about 4.5 mg/g, between about 0.3 and about 4 mg/g, between about 0.4 and about 3.5 mg/g, between about 0.5 and about 3 mg/g, between about 0.6 and about 2.5 mg/g, between about 0.7 and about 2 mg/g, between about 0.8 and about 1.5 mg/g, between about 0.9 and about 1 mg/g, or about 1 mg/g of builder. The cationic polymer may be present in an amount of no more than 0.1 mg/g of builder, 0.2 mg/g, 0.3 mg/g, 0.4 mg/g, 0.5 mg/g, 0.6 mg/g, 0.7 mg/g, 0.8 mg/g, 0.9 mg/g, 1.0 mg/g, 1.5 mg/g, 2.0 mg/g, 2.5 mg/g, 3.0 mg/g, 3.5 mg/g, 4.0 mg/g, 4.5 mg/g, or no more than 5.0 mg/g of builder.

The cationic polymer may be present in an amount of at least about 0.1 mg/g of builder, about 0.2 mg/g, about 0.3 mg/g, about 0.4 mg/g, about 0.5 mg/g, about 0.6 mg/g, about 0.7 mg/g, about 0.8 mg/g, about 0.9 mg/g, about 1.0 mg/g, about 1.5 mg/g, about 2.0 mg/g, about 2.5 mg/g, about 3.0 mg/g, about 3.5 mg/g, about 4.0 mg/g, about 4.5 mg/g, about 5.0 mg/g, about 6.0 mg/g, about 7.0 mg/g, about 8.0 mg/g, about 9.0 mg/g, about 10.0 mg/g, about 12.5 mg/g, about 15 mg/g, about 17.5 mg/g, about 20.0 mg/g, about 25 mg/g, about 30 mg/g, about 35 mg/g, about 40 mg/g, about 45 mg/g. about 50 mg/g, about 60 mg/g, about 70 mg/g, about 80 mg/g, about 90 mg/g, or at least about 100 mg/g of builder.

Beneficially, the amount of cationic polymer used is in the present invention may be significantly lower compared to the amount of active component(s) used in conventional detergent compositions. As such, the present invention is comparably more cost effective than conventional detergent compositions. Moreover, due to the reduced amount of active component used, the present invention exhibits reduced risks with regard to safety and aquatic toxicity. Further, the granular form of the inventive additive allows for a more homogenous distribution of the cationic polymer across individual products, therefore, a significantly lower amount of active component, i.e. the cationic polymer of the invention, can be used in manufacture of the invention while still ensuring that the final consumer product delivers the claimed performance benefits associated with the active component. Moreover, providing the inventive additive in granular form, and the small amount of active component required to deliver the claimed performance benefits, allows for only minor modifications to current manufacturing methods and parameters to produce the inventive composition. Thus, there are no major processing challenges envisaged with the inventive composition.

The cationic polymer may be selected from the family of polycationic polymers designated as polyquaternium polymers under the International Nomenclature for Cosmetic Ingredients, in particular the cationic polymer may be Polyquaternium-2, Polyquaternium-4, Polyquaternium-6, Polyquaternium-7 or Polyquaternium-10, or any polycationic polymer which exhibits strong hydrogen bonding and adsorption to SiO₂ surfaces. Preferably, the cationic polymer is Polyquaternium-2.

The builder may be selected from the group containing hydroxycarboxylates, aminocarboxylates, dicarboxylic acid amines and/or phosphates, or the salts thereof, or mixtures thereof. The hydroxycarboxylates may be, for example, a citrate salt, for example trisodium citrate, which may be anhydrous. The aminocarboxylate may be, for example, methyl glycine diacetic acid (MGDA), N,N-dicarboxymethyl glutamic acid (GLDA), or mixtures thereof. The dicarboxylic acid amine may be, for example, iminodisuccinic acid (IDS). The phosphate may be, for example, tripolyphosphate.

The builder may be selected from the group containing aspartic acid- N-monoacetic acid (ASMA), aspartic acid-N,N-diacetic acid (ASDA), aspartic acid-N-monopropionic acid (ASMP), iminodisuccinic acid (IDA), N-(2- sulfomethyl) aspartic acid (SMAS), N-(2-sulfoethyl)aspartic acid (SEAS), N-(2- sulfomethyl)glutamic acid (SMGL), N-(2- sulfoethyl)glutamic acid (SEGL), N- methyliminodiacetic acid (MIDA), a- alanine-N,N-diacetic acid (a-ALDA), β- alanine-N,N-diacetic acid (D-ALDA), serine-N,N-diacetic acid (SEDA), isoserine- N,N-diacetic acid (ISDA), phenylalanine-N,N-diacetic acid (PHDA), anthranilic acid-N, N- diacetic acid (ANDA), sulfanilic acid-N, N-diacetic acid (SLDA), taurine- N. N-diacetic acid (TUDA) and sulfomethyl-N, N-diacetic acid (SMDA) and (hydroxy)iminodisuccinic acid (HIDS) and alkali metal salts or ammonium salts thereof, or mixtures thereof.

The total amount of builder present in the granular additive may be at least 5% by weight, at least 10% by weight, at least 15% by weight, at least 20% by weight, at least 25% by weight, at least 30% by weight, at least 35% by weight, at least 40% by weight, at least 45% by weight, at least 50% by weight, at least 55% by weight, at least 60% by weight, at least 65% by weight, at least 70% by weight, at least 75% by weight, at least 80% by weight, at least 83% by weight, at least 85% by weight, at least 90% by weight, or at least 95% by weight of the granular additive composition.

The total amount of builder present in the granular additive may be in an amount of up to 90% by weight, 85% by weight, up to 80% by weight, up to 75% by weight, up to 70% by weight, up to 65% by weight, up to 60% by weight, up to 55% by weight, up to 50% by weight, up to 45% by weight, up to 40% by weight, up to 35% by weight, up to 30% by weight, up to 25% by weight, up to 20% by weight, up to 15% by weight, up to 10% by weight, or up to 5% by weight of the granular additive composition.

The total amount of builder present in the granular additive may be in an amount of between at least 70% by weight and at least 99% by weight, between at least 75% by weight and at least 95% by weight, between at least 80% by weight and at least 90% by weight, between at least 81% by weight and at least 87% by weight, between at least 82% by weight and at least 85% by weight, or at least 83% by weight of the granular additive composition.

The granular additive may further comprise a co-builder selected from the group containing polymers, co-polymers, polycarboxylates, hydroxycarboxylic acids, phosphonates, or mixtures thereof. Suitable examples of each type of co-builder are listed in the section below headed “Cleaning Actives”.

The granular additive may have a particle size from about 200 to about 1400 μm, preferably from about 300 to about 1200 μm, even more preferably from about 500 to about 800 μm, as measured by sieving.

The granular additive may have a particle size from about 200 to about 1200 μm, from about 225 to about 1100 μm, or from about 250 to about 1000 μm, as measured by sieving.

The granular additive may further comprise a silicate source. The silicate source may be an alkali metal silicate or/and any other source that provides sufficient amount of silicate during the dishwashing process, for example a material selected from the group comprising amorphous silica, colloidal silica, ester of silica and water-soluble glass or any combination thereof. The alkali metal silicate may be selected from the group consisting of sodium silicate, potassium silicate and mixtures thereof, preferably sodium silicate.

The silicate source may be present in an amount of at least about 1% wt., 2% wt., 3%-wt, 4% wt., 5% wt., 6% wt., 7% wt., 8% wt., 9% wt., 10% wt., 12% wt., 14% wt., 16% wt., 18% wt., 20% wt., 22% wt., 24% wt., 26% wt., 28% wt., or at least 30% wt., based on the weight of the granular additive composition.

The granular additive may further comprise a source of phosphorus. The source of phosphorus may be any phosphate or phosphonate.

According to a second aspect of the invention there is provided a detergent composition comprising a granular additive of the first aspect of the invention.

The granular additive of the first aspect of the invention may be present in an amount of between about 0.1 and about 50 mg/g of detergent composition, between about 0.2 and about 45 mg/g, between about 0.3 and about 40 mg/g, between about 0.4 and about 35 mg/g, between about 0.5 and about 30 mg/g, between about 0.6 and about 25 mg/g, between about 0.7 and about 20 mg/g, between about 0.8 and about 15 mg/g, between about 0.9 and about 10 mg/g, between about 1 and about 10 mg/g, between about 1.2 and about 9.0 mg/g, between about 1.5 and about 8.0 mg/g, between about 1.8 and about 7.0 mg/g, or preferably between about 2.0 and about 6.0 mg/g of detergent composition.

The granular additive of the first aspect of the invention may be present in an amount of at least about 0.1 g, at least about 0.5 g, at least about 1.0 g, at least about 1.5 g, at least about 2.0 g, at least about 2.5 g, at least about 3.0 g, at least about 3.5 g, at least about 4.0 g, at least about 4.5 g, at least about 5.0 g, at least about 5.5 g, at least about 6.0 g, at least about 6.5 g, at least about 7.0 g, at least about 7.5 g, at least about 8.0 g, at least about 8.5 g, at least about 9.0 g, at least about 9.5 g, or at least about 10 g, in each detergent composition.

The granular additive of the first aspect of the invention may be present in an amount of at least about 0.1 mg/g of detergent composition, at least about 0.2 mg/g, at least about 0.3 mg/g, at least about 0.4 mg/g, at least about 0.5 mg/g, at least about 0.6 mg/g, at least about 0.7 mg/g, at least about 0.8 mg/g, at least about 0.9 mg/g, at least about 1.0 mg/g, at least about 1.5 mg/g, at least about 2.0 mg/g, at least about 2.5 mg/g, at least about 3.0 mg/g, at least about 3.5 mg/g, at least about 4.0 mg/g, at least about 4.5 mg/g, at least about 5.0 mg/g, at least about 5.5 mg/g, at least about 6.0 mg/g, at least about 6.5 mg/g, at least about 7.0 mg/g, at least about 7.5 mg/g, at least about 8.0 mg/g, at least about 8.5 mg/g, at least about 9.0 mg/g, at least about 9.5 mg/g, or at least about 10.0 mg/g of detergent composition.

The granular additive of the first aspect of the invention may be present in an amount of at least about 10 mg/g of detergent composition, at least about 20 mg/g, at least about 30 mg/g, at least about 40 mg/g, at least about 50 mg/g, at least about 60 mg/g, at least about 70 mg/g, at least about 80 mg/g, at least about 90 mg/g, at least about 100 mg/g, at least about 125 mg/g, at least about 150 mg/g, at least about 175 mg/g, at least about 200 mg/g, at least about 225 mg/g, at least about 250 mg/g, at least about 275 mg/g, at least about 300 mg/g, at least about 325 mg/g, at least about 350 mg/g, at least about 375 mg/g, at least about 400 mg/g, at least about 425 mg/g, at least about 450 mg/g, at least about 475 mg/g, or at least about 500 mg/g, of detergent composition.

The granular additive of the first aspect of the invention may be present in an amount of between about 10 and about 500 mg/g of detergent composition, preferably between about 50 and about 400 mg/g of detergent composition.

The cationic polymer may be present in an amount between about 0.001 and about 0.5% wt., between about 0.002 and about 0.45% wt., between about 0.003 and about 0.4% wt., between about 0.004 and about 0.35% wt., between about 0.005 and about 0.3% wt., between about 0.006 and about 0.25% wt., between about 0.007 and about 0.2% wt., between about 0.008 and about 0.15% wt., between about 0.009 and about 0.1% wt., or between about 0.01 and about 0.05% wt., based on the weight of the detergent composition, and the same may be released during a dishwashing cycle, laundry cycle, or stages thereof, to which the granular additive is applied.

The cationic polymer may be present in an amount between about 1 and about 100 mg, between about 1 and about 75 mg, between about 1 and about 50 mg, between about 1 and about 40 mg, between about 1 and about 30 mg, between about 1 and about 25 mg, between about 1 and about 20 mg, between about 1 and about 15 mg, between about 1 and about 10 mg, between about 1 and about 9 mg, between about 1 and about 8 mg, between about 1 and about 7 mg, between about 1 and about 6 mg, or between about 1 and about 5 mg, based on the weight of the detergent composition, and the same may be released during a dishwashing cycle, laundry cycle, or stages thereof, to which the granular additive is applied.

Advantageously, providing the inventive additive in granular form reduces the amount of granular additive and, therefore, cationic polymer, required to manufacture the detergent composition. This is because the granular form of the inventive additive allows for a more homogenous distribution of the cationic polymer across individual products, therefore, ensuring that the final consumer product delivers the claimed performance benefits associated with the active component. Moreover, providing the inventive additive in granular form eliminates dust formation which is encountered when producing detergent compositions comprising fine powders. As such, the present invention is comparably safer and easier to handle than detergent compositions which rely on fine powders.

The builder may be present in the detergent composition in an amount of at least about 0.1 g, at least about 0.2 g, at least about 0.3 g, at least about 0.4 g, at least about 0.5 g, at least about 0.6 g, at least about 0.7 g, at least about 0.8 g, at least about 0.9 g, at least about 1.0 g, at least about 1.2 g, at least about 1.4 g, at least about 1.6 g, at least about 1.8 g, at least about 2.0 g, at least about 2.5 g, at least about 3.0 g, at least about 3.5 g, at least about 4.0 g, at least about 4.5 g, at least about 5.0 g, at least about 5.5 g, at least about 6.0 g, at least about 6.5 g, at least about 7.0 g, at least about 7.5 g, at least about 8.0 g, at least about 8.5 g, at least about 9.0 g, at least about 9.5 g, or at least about 10 g.

The detergent composition may include any suitable dishwashing or laundry detergent ingredients, which may be selected from the group comprising a builder in addition to the builder of the invention, a surfactant, a bleach, a bleach activator, an enzyme, an alkalinity source, an acid source, a processing aid, a colourant, a perfume, an antifoam agent, a further polymer, a foam-control agent, an anti-corrosion agent, a preservative or any combination thereof. Suitable examples of each type of detergent ingredients are listed in the section below headed “Cleaning Actives”.

The detergent composition according to the second aspect may optionally include any of the optional features of the invention according to the first aspect.

According to a third aspect, there is provided a package or device containing a granular additive according to the first aspect of the invention or a detergent composition of the second aspect of the invention.

The package or device may be a multi-compartment capsule or container. The multi-compartment capsule or container may comprise 2 or more, 3 or more, or 4 or more compartments. The granular additive or detergent composition may be located in at least one compartment.

The at least one compartment which comprises the granular additive or detergent composition may further comprise a solid composition comprising one or more cleaning actives, or a liquid composition comprising one or more cleaning actives, or a gel composition comprising one or more cleaning actives. Suitable examples of cleaning actives are listed in the section below headed “Cleaning Actives”.

Beneficially, a multi-compartment capsule or container also allows compositions of different forms (i.e. solid form, liquid form or gel form) to be located within different compartments. Such a capsule or container is aesthetically more appealing to consumers.

The package may comprise a water-soluble container or capsule. The water-soluble container or capsule may comprise a polyvinyl alcohol capsule or container, preferably a thermoformed polyvinyl alcohol capsule or container, especially a thermoformed polyvinyl alcohol multi-compartment capsule or container.

The water-soluble capsule or container may comprise or be a water-soluble film. The water-soluble film may be rigid or flexible at room temperature.

Preferably, the water-soluble capsule or container comprises or is made of a poly(vinyl alcohol)(PVOH) film. The PVOH film may be partially or fully alcoholised or hydrolysed, for example, it may be from 40 to 100%, preferably 70 to 92%, most preferably about 85% to about 92%, alcoholised or hydrolysed, polyvinyl acetate film.

The degree of hydrolysis is known to influence the temperature at which the PVOH starts to dissolve in water, 88% hydrolysis corresponds to a film soluble in cold (i.e. room temperature) water, whereas 92% hydrolysis corresponds to a film soluble in warm water. The film may be cast, blown or extruded. It may further be unoriented, mono-axially oriented or bi-axially oriented.

The PVOH film may be a thermoformed PVOH film.

The water-soluble container may be a multi-compartment water-soluble container. The multi-compartment water-soluble capsule or container may comprise two or more, three or more, four or more, five or more, or six or more separated compartments. Each of the compartments may be arranged side-by-side, concentrically, as sectors of a circle or in any suitable random or organised pattern. The capsule or container may comprise a first PVOH film comprising a pocket and a surrounding flange, and a second PVOH film, applied as a cover across the pocket and sealed across the flange. The granular additive or detergent composition may be located in the pocket. The capsule or container may comprise a first PVOH film comprising more than one pocket, for example two or more, three or more, four or more, five or more, or six or more pockets, and a surrounding flange, and a second PVOH film, applied as a cover across each pocket and sealed across the flange. In some embodiments there are three or four pockets.

Different forms of the granular additive may be located in different compartments of a multi-compartment capsule or container. For example, the package may comprise a multi-compartment package in which a first form of the granular additive is located in a first compartment, for example the granular additive suspended within a gel, and a second form of the granular additive is located in a second compartment, for example the granular additive as free granules.

In some embodiments the package comprises a multiple-compartment capsule or container comprising at least one compartment filled with a granular additive of the first aspect of the invention or a detergent composition of the second aspect of the invention, and at least one further compartment filed with at least one detergent ingredient or detergent composition. In some embodiments, at least one compartment is filled with a granular additive of the invention and at least two further compartments are filled with different detergent ingredients or detergent compositions.

The builder and cationic polymer of the granular additive or detergent composition may be mixed with other ingredients or may be separated therefrom. For example, the inventive composition may take the form of a multi-compartment capsule or container and the builder and cationic polymer may be mixed together and located in one compartment with the remainder of any optional ingredients located in one or more other compartments: the builder may be located in one compartment, the cationic polymer located in another compartment and the remainder of other optional ingredients located in one or more other compartments; or the builder and cationic polymer may be mixed together or separately with other optional ingredients in two or more compartments.

In other embodiments the device comprises a reservoir of the granular additive or detergent composition of the invention and at least one dispensing aperture through which the granular additive or detergent composition is ejected. The dispensing aperture may dispense the granular additive or detergent composition continuously or at defined or timed intervals, or may be arranged to dispense the granular additive or detergent composition at a particular stage of the wash cycle, for example during the pre-wash and/or during the main wash, or after the main wash.

The package may comprise a unit-dose format for a single use. In case of a dose for a single wash cycle, the packages of the present invention may contain at least 0.1 g, 0.2 g, 0.3 g, 0.4 g, 0.5 g, 0.6 g, 0.7 g, 0.8 g, 0.9 g, 1.0 g, 1.5 g, 2.0 g, 2.5 g, 3.0 g, 3.5 g, 4.0 g, 4.5 g, 5.0 g, 5.5 g, 6.0 g, 6.5 g, 7.0 g, 7.5 g, 8.0 g, 8.5 g, 9.0 g, 9.5 g, or at least 10.0 g, of granular additive or detergent composition, such as from 1.0 to 50 g, especially from 5 to 30 g, in particular between 10 g and 25 g. Other ingredients may be used as fillers to reach the intended amount. These fillers may be as described herein, and may be powders like sodium sulphates, crystals like sugar, liquids like water or other liquids, and the like. Further auxiliary ingredients like fragrance or dyes can also be used in such a single wash dose.

The package or device may comprise a multi-cycles package or device; that is, the package or device may be structured to release the granular additive or detergent composition of the invention across multiple cycles of washing, and may either be added to a dishwasher or laundry washing machine and left for multiple cycles or may be removed and replaced for each cycle. The multi-cycles package or device may comprise a plurality of doses of the granular additive or detergent composition of the invention. The plurality of doses may be arranged to release one dose at any defined time period, such as once every wash cycles, once every stage in every wash cycle or at two or more stages in every wash cycle, for example. The multi-cycle device may comprise a block of the granular additive or detergent composition of the invention in solid form which is arranged to dissolve in use to release a dose of additive at the desired time(s) during each cycle. If the package or device comprises a multi-cycles block, capsule, or gadget, for each dishwashing cycle it may comprise for example between 1 to 20 g of a composition containing sufficient amounts of the inventive additive for providing consumer-related benefits, in particular glass protection.

The package or device according to the third aspect may optionally include any of the optional features of the invention according to the first or second aspect.

According to a fourth aspect, there is provided the use of a granular additive according to the first aspect, or a detergent composition according to the second aspect, or a package or device according to the third aspect, for treating or washing soiled kitchenware. The kitchenware may comprise tableware or kitchenware made of, or comprising an element made of, glass, for example drinking cups and vessels, baking dishes, mixing bowls and airtight containers.

The invention according to the fourth aspect may optionally include any of the optional features of the invention according to the first to third aspects.

According to a fifth aspect, there is provided a method of treating or washing kitchenware in a dishwashing machine, wherein a granular additive of the first aspect, or a detergent composition of the second aspect, or a package or device of the third aspect is added to the dishwashing machine.

The dishwashing machine may be an automatic dishwashing machine.

The method of the fifth aspect, in some embodiments, may comprise, in any order, adding the builder and cationic polymer (together or separately) to the wash fluid of the dishwashing machine, and separately adding the remaining ingredients of a dishwashing detergent composition to the wash fluid of the dishwashing machine. For example, the method may comprise adding the builder and cationic polymer before or after adding the remaining ingredients. This may be achieved by providing a multi-compartment package of the invention, in which the builder and cationic polymer are in a separate compartment of a water-soluble package to the remaining ingredients, said separate compartment being configured to dissolve before or after the other compartment or compartments (or at least one other compartment), during a wash cycle. Or may be achieved by providing the invention into the prewash and/or beginning of the main wash, and/or into any other step of the washing process before or after a state of the art detergent or detergent ingredients is/are dispensed.

The method for treating or washing kitchenware in a dishwashing machine may comprise adding the granular additive of the first aspect of the invention, the detergent composition according to the invention in its second aspect, or a package or device according to the invention in its third aspect, to the dishwashing machine at the start of a main wash cycle, the pre-wash cycle or at the start of the final rinse cycle (or any combination thereof).

The invention according to the fifth aspect may optionally include any of the optional features of the invention according to any of the former aspects.

According to a sixth aspect of the invention, there is provided the use of a granular additive of the first aspect, a detergent composition of the second aspect and/or a package or device of the third aspect for reducing glass corrosion.

The use may be for reducing glass corrosion of kitchenware made of, or comprising an element made of, glass, such as drinking cups and vessels, baking dishes, mixing bowls and airtight containers. The use may be reducing glass corrosion of kitchenware during a wash cycle of an automatic dishwasher.

The invention according to the sixth aspect may optionally include any of the optional features of the invention according to any of the former aspects.

According to a seventh aspect of the invention, there is provided the use of a granular additive of the first aspect and/or a package or device of the third aspect for domestic cleaning or treatment.

Domestic cleaning and treatment may comprise automatic dishwashing, hard surface cleaning, for example the cleaning of an element made of glass, water treatment and laundry washing.

The granular additive of the first aspect and/or a package or device of the third aspect may form an element of a laundry detergent composition for laundry washing.

The invention according to the seventh aspect may optionally include any of the optional features of the invention according to any of the former aspects.

According to a eighth aspect of the invention, there is provided a method for preparing a granular additive according to the invention in its first aspect, the method comprising the step of:
a. mixing a builder with a cationic polymer, wherein the cationic polymer has a pH-independent permanent positive charge.

The method may further comprise stirring the builder and the cationic polymer. The builder and the cationic polymer may be stirred until a lump-free composition is formed. The builder and the cationic polymer may be stirred until a homogenous powder is formed. The cationic polymer may be in the form of an aqueous solution. The cationic polymer may be added to the builder using a spraying technique.

The builder and cationic polymer may each be in the form of an aqueous solution. The builder and cationic polymer may be mixed to form a mixed solution.

The method may further comprise spray-drying the mixed solution comprising the builder and the cationic polymer.

The method may further comprise heating the mixed solution to a temperature of between about 40 and about 120° C., between about 50 and about 110° C., between about 60 and about 100° C., between about 70 and about 90° C., or about 80° C., prior to spray-drying.

The mixed solution may be spray-dried in a co-current spray-drying tower. The mixed solution may be spray-dried in a co-current spray-drying tower using an air inlet temperature of between about 140 and about 300° C., between about 160 and about 280° C., between about 180 and about 260° C., between about 200 and about 240° C., between about 210 and about 230° C. or about 220° C. The mixed solution may be spray-dried in a co-current spray-drying tower using an air outlet temperature of between about 60 and about 160° C., between about 70 and about 150° C., between about 80 and about 140° C., between about 90 and about 130° C., between about 100 and about 120° C. or about 110° C.

The method may further comprise spray-drying the mixed solution in a co-current spray-drying tower to form particles having a moisture content of between 5 and 15% wt., between 8 and 14% wt., between 9 and 12% wt., or about 10% wt.

A rotating disc atomizer may be used for slurry droplet formation in the spray-dryer. Slurry droplets may be formed in the spray-dryer using an atomising air pressure of between 3 and 9 bar, between 4 and 8 bar, between 5 and 7 bar, or about 6 bar.

Slurry droplets may be formed in the spray-dryer using an atomising airflow of between about 40 and about 90%, between about 45 and about 85%, between about 50 and about 80%, between about 55 and about 75%, between about 60 and about 70%, or about 65%.

The method may further comprise compacting spray-dried particles into compacted aggregates using a compaction pressure between about 70 and about 160 bar, between about 80 and about 150 bar, between about 90 and about 140 bar, between about 100 and about 130 bar, or between about 110 and about 120 bar.

The method may further comprise sieving the spray-dried particles. The spray-dried particles may be sieved to obtain an average particle size of around 0.05 mm to 0.15 mm, in particular an average particle size of around 0.1 mm or less than 0.1 mm.

The spray-dried particles may comprise no more than 0.04 wt. % of cationic polymer, 0.05 wt. %, 0.06 wt. %, 0.07 wt. %, 0.08 wt. %, 0.09 wt. %, or no more than 0.10 wt. % of cationic polymer.

The method may further comprise adding a silicate to the builder and cationic polymer mixture. The silicate may be sodium silicate, potassium silicate or a mixture thereof. The builder may be anhydrous. The builder may be anhydrous trisodium citrate.

The invention according to the eighth aspect may optionally include any of the optional features of the invention according to any of the former aspects.

One or more of the following cleaning active categories may be present in the granular additive of the invention, the detergent composition of the invention or in any detergent located in any compartment of a multi-compartment package or device of the invention, as desired. More than one ingredient from each cleaning active category may be present, if a cleaning active category is present in the granular additive, detergent composition, package or device of the invention.

### Cleaning Actives

If the inventive composition may be used as part of a dishwashing detergent, it can be used in combination with their state of the art ingredients. Those skilled in the art will appreciate that where the term “detergent” is used herein, this does also include rinse aid and other additive compositions used to be applied during dishwashing in a dishwasher. The granular additive or the detergent composition may comprise one or more active components which may be selected from surfactants, alkalinity sources, acidity sources (especially for rinse aid and machine cleaner), builders, enzymes, polymers, anti-corrosion agents, bleach, care agents and other auxiliary ingredients like fragrance, dye, etc.

The granular additive or the detergent composition may comprise any ingredients known in the art.

### Builder

The granular additive or the detergent composition may comprise one or more builder(s) in addition to the builder of the present invention. The builder may be either a phosphate-containing builder or a phosphate-free builder, or a mixture of each, as desired. In many countries, including the United States and in the European Union, phosphate builders are restricted and so phosphate-free builders are preferred.

The phosphate-free builder may also or alternatively comprise non- polymeric organic molecules with one or more carboxylic group(s). Builder compounds which are organic molecules comprising carboxylic groups may include citric acid, fumaric acid, tartaric acid, maleic acid, lactic acid and salts thereof. The alkali or alkaline earth metal salts of these organic compounds may be used, in particular, but not limited to, the sodium salts. The phosphate-free builder may be sodium citrate.

The phosphate-free co-builder may be one or more polycarboxylate(s) which comprise two carboxyl groups, for example, water-soluble salts of, malonic acid, (ethylenedioxy)diacetic acid, maleic acid, diglycolic acid, tartaric acid, tartronic acid and fumaric acid. The phosphate-free co-builder may be one or more polycarboxylate(s) which comprise three carboxyl groups, for example, water-soluble citrate. The phosphate-free co-builder may be one or more hydroxycarboxylic acid, for example, citric acid.

If phosphate-containing builders are to be used, the phosphate-containing builder may be selected from one or more of phosphonates, for example 1-Hydroxyethylidene-1.1-diphosphonic acid (HEDP), monophosphates, di-phosphates, tri-polyphosphates or oligomeric-poylphosphates, or its alkali metal salt, in particular, but not limited to, its sodium salt, for example sodium tripolyphosphate (STPP).

Conventional amounts of the phosphate-containing builders may be used, typically in the range of from 15% by weight to 70% by weight, or from 20% by weight to 60% by weight, or from 25% by weight to 50% by weight. If additional phosphate-free builder is included, the phosphate-free builder may be chosen from succinate based compounds. It is intended that the term ‘succinate based compound’ includes succinic acid based compounds, and such terms may be used interchangeably herein. Conventional amounts of the succinate based compounds may be used, typically in the range of from 5% by weight to 80% by weight, or from 15% by weight to 70% by weight, or from 20% by weight to 60% by weight. The compounds may be used individually or as a mixture.

The granular additive or the detergent composition may include other suitable builders, for example, glutamic acid N,N-diacetic acid (GLDA), methylglycinediacetic acid (MGDA), aspartic acid- N-monoacetic acid (ASMA), aspartic acid-N,N-diacetic acid (ASDA), aspartic acid-N- monopropionic acid (ASMP), iminodisuccinic acid (IDA). N-(2- sulfomethyl) aspartic acid (SMAS), N-(2-sulfoethyl)aspartic acid (SEAS), N-(2- sulfomethyl)glutamic acid (SMGL), N-(2- sulfoethyl)glutamic acid (SEGL), N- methyliminodiacetic acid (MIDA), a- alanine-N,N-diacetic acid (a-ALDA), β- alanine-N,N-diacetic acid (p-ALDA), serine-N,N-diacetic acid (SEDA), isoserine- N,N-diacetic acid (ISDA), phenylalanine-N,N-diacetic acid (PHDA), anthranilic acid-N, N- diacetic acid (ANDA), sulfanilic acid-N, N-diacetic acid (SLDA), taurine- N, N-diacetic acid (TUDA) and sulfomethyl-N, N-diacetic acid (SMDA), tetrasodium imminosuccinate, iminodisuccinic acid (IDS) and (hydroxy)iminodisuccinic acid (HIDS) and alkali metal salts or ammonium salts thereof, or mixtures thereof.

The builder may comprise homopolymers and copolymers of polycarboxylic acids and their partially or completely neutralised salts, monomeric polycarboxylic acids and hydroxycarboxylic acids and their salts, phosphates and phosphonates, and mixtures thereof. The salts of the abovementioned compounds may be the ammonium and/or alkali metal salts, i.e. the lithium, sodium, or potassium salt.

The builder may be an organic builder.

The total amount of builder present in the granular additive or the detergent composition may be at least 5% by weight, at least 10% by weight, at least 15% by weight, at least 20% by weight, at least 25% by weight, at least 30% by weight, at least 35% by weight, at least 40% by weight, at least 45% by weight, or at least 50% by weight.

The total amount of builder present in the granular additive or the detergent composition may be in an amount of up to 80% by weight, up to 70% by weight, up to 60% by weight, up to 50% by weight, or up to 45% by weight. The actual amount used in the detergent composition may depend upon the nature of the builder used.

### Surfactant

The granular additive or the detergent composition may include one or more surfactant(s). The surfactant may be any of non-ionic, anionic, cationic, amphoteric or zwitterionic surface active agents, or suitable mixtures thereof. Preferably, the surfactant is a non-ionic surfactant. The non-ionic surfactant may be an ethoxylated non-ionic surfactant prepared by the reaction of a monohydroxy alkanol with 6 to 20 carbon atoms. The surfactant may have at least 12 moles, at least 16 moles, at least 20 moles, or at least 25 moles, of ethylene oxide per mole of alcohol. The non-ionic surfactant may be from a linear chain fatty alcohol with 16-20 carbon atoms and at least 12 moles, at least 16 moles, or at least 20 moles, of ethylene oxide per mole of alcohol.

The non-ionic surfactant may additionally comprise propylene oxide units in the surfactant molecule. The propylene oxide units may constitute up to 25% by weight, up to 20% by weight, or up to 15% by weight of the overall molecular weight of the non-ionic surfactant.

The surfactant may be an ethoxylated mono-hydroxy alkanols which additionally comprise polyoxyethylene-polyoxypropylene block copolymer units. The alcohol portion of the ethoxylated mono-hydroxy alkanols may constitute more than 30% by weight, more than 50% by weight, or more than 70% by weight of the overall molecular weight of the non-ionic surfactant. The non-ionic surfactant may comprise reverse block copolymers of polyoxyethylene and polyoxypropylene and block copolymers of polyoxyethylene and polyoxypropylene initiated with trimethylolpropane.

The non-ionic surfactant may be a surfactant described by the formula:

R¹O[CH₂CH(CH₃)O]X[CH₂CH₂O]Y[CH₂CH(OH)R²]

where R¹ represents a linear or branched chain aliphatic hydrocarbon group with 4-18 carbon atoms or a mixture thereof. R² represents a linear or branched chain aliphatic hydrocarbon rest with 2-26 carbon atoms or a mixture thereof, x is a value between 0.5 and 1.5, and y is a value of at least 15.

The non-ionic surfactant may be an end-capped polyoxyalkylated non-ionic surfactant of the formula:

R¹O[CH₂CH(R₃)O]X[CH₂]kCH(OH)[CH₂]jOR²

where R¹ and R² represent linear or branched chain, saturated or unsaturated, aliphatic or aromatic hydrocarbon groups with 1-30 carbon atoms, R³ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5, more preferably k=1 and j=1. When the value of x is greater than 2, each R³ in the formula above may be different. R¹ and R² are preferably linear or branched chain, saturated or unsaturated, aliphatic or aromatic hydrocarbon groups with 6-22 carbon atoms, preferably 8 to 18 carbon atoms. For the group R³, H, methyl or ethyl is particularly preferred. Particularly preferred values for x are comprised between 1 and 20, preferably between 6 and 15.

As described above, where the value of x is greater than 2, each R³ in the formula can be different. For example, when x=3, R³ may be ethylene oxide (EO) (R³═H) or propylene oxide (PO) (R³=methyl) units which can be used in any order, for example (POXEO)(EO), (EOXPO)(EO), (EOXEO)(PO), (EO)(EOXEO), (PO)(EOXPO), (POXPOXEO) and (PO)(PO)(PO).

The granular additive or the detergent composition may comprise a non-ionic surfactant comprising a mixture of alkoxylated alcohols and hydroxy-group containing alkoxvlated alcohols.

The granular additive or the detergent composition may comprise a non-ionic surfactant in an amount of from 0.1% by weight to 20% by weight, 1% by weight to 15% by weight, or 2% to 10% by weight, based on the total weight of the granular additive or the detergent composition.

### Enzyme

The granular additive or the detergent composition may comprise one or more enzyme(s). The enzyme may be selected from the group containing protease, lipase, amylase, cellulase and peroxidase, or mixtures thereof. Preferably, the enzyme may be protease or amylase, or a mixture thereof. Advantageously, enzymes, in particular, but not limited to, protease and amylase, are especially effective in providing favourable cleaning efficacy in dishwashing detergent compositions. Any suitable species of these enzymes may be used as desired. More than one species may be used.

The granular additive or the detergent composition may comprise at least 0.001 mg, at least 0.01 mg, or at least 0.1 mg of active enzyme per gram of detergent composition.

The granular additive or the detergent composition may comprise from about 1.5 to about 10 mg, from about 1.8 to about 5 mg, or from about 2 to about 4 mg of active enzyme per gram of detergent composition.

### Bleach

The granular additive or the detergent composition may comprise one or more bleach additive or bleach activation catalyst. The bleach additive may be an organic peracid, for example perbenzoic acid and peroxycarboxylic acids e.g. phthalimido peroxy caproic acid (PAP). Advantageously, organic peracids do not require the use of a bleach activator or catalyst as these bleaches are active at relatively low temperatures, for example at about 30° C. and this contributes to such bleach materials being preferred according to the present invention.

The granular additive or the detergent composition may comprise one or more bleach activator or bleach catalyst, dependent on the nature of the bleaching compound. The bleach activator may be Tetraacetylethylenediamine (TAED). The bleach catalyst may be manganese oxalate, manganese acetate or a dinuclear manganese complex.

The granular additive or the detergent composition may comprise water.

### Acidity and Alkalinity

The granular additive or the detergent composition may comprise a source of acidity or a source of alkalinity, to obtain the desired pH on dissolution. A source of acidity may be any acidic compound, for example a polycarboxylic acid, for example citric acid. A source of alkalinity may be a carbonate or bicarbonate (such as an alkali metal or alkaline earth metal salt). A source of alkalinity may be any basic compound, for example any salt of a strong base and a weak acid. Non-limiting examples of an alkalinity source include an alkali hydroxide, alkali hydride, alkali oxide, alkali sesquicarbonate, alkali carbonate, alkali borate, alkali salt of mineral acid, alkali amine, alkaloid, or mixtures thereof. The alkalinity source may be sodium carbonate, sodium hydroxide or potassium hydroxide. The source of alkalinity may be present in an amount sufficient to give the wash liquor a pH of from about 8 to about 12, preferably from about 9 to about 11.5. The detergent composition may comprise from about 1% to about 40%, or from about 2% to 20% by weight of the composition, of a source of alkalinity.

The source of alkalinity may comprise a source of univalent ions. Beneficially, univalent ions contribute to high alkalinity and, advantageously, only minimally raise the ionic strength of the wash solution. The alkalinity source may be a metal hydroxide, for example, sodium or potassium hydroxide.

### Anti-Corrosion Agent

The granular additive or the detergent composition may comprise one or more anti-corrosion agent(s). Anti-corrosion agents may provide further benefits against corrosion of glass and/or metal and the term encompasses agents that are intended to prevent or reduce the tarnishing of non-ferrous metals, in particular of silver and copper.

The granular additive or the detergent composition may comprise multivalent ions, for example zinc, bismuth and/or manganese ions. Beneficially, these multivalent ions may further inhibit corrosion of glass and/or metal.

The detergent composition may comprise polymers for inhibit corrosion of glass and/or metal like polyalkylenimmines and/or polyquats.

The granular additive or the detergent composition may comprise organic and inorganic redox-active substances which are known as suitable for use as silver/copper corrosion inhibitors. The inorganic redox-active substances may be metal salts and/or metal complexes chosen from the group consisting of zinc, bismuth, manganese, titanium, zirconium, hafnium, vanadium, cobalt and cerium salts and/or complexes thereof, the metals being in one of the oxidation states 11, 111, IV, V or VI. The metal salts and/or metal complexes may be chosen from the group consisting of MnSO₄. Mn(ll) citrate, Mn(ll) stearate, Mn(ll) acetylacetonate, Mn(ll) [1-hydroxyethane-1, 1-diphosphonate], V₂O₅, V₂O, VO₂, TiOSO₄, K₂TiF₆, K₂ZrF₆, CoSO₄, Co(NO₃)₂, zinc acetate, zinc sulphate and Ce(NO₃)₂. The source of multivalent ions may be chosen from sulphates, carbonates, acetates, gluconates and metal-protein compounds.

The granular additive or the detergent composition may comprise one or more silver/copper anti-corrosion agent(s), for example benzotriazole (BTA) or bis-benzotriazole, or substituted derivatives thereof, for example tolyltriazole.

Benzotriazole derivatives are those compounds in which the available substitution sites on the aromatic ring are partially or completely substituted, for example linear or branch-chain C₁₋₂₀ alkyl groups and hydroxyl, thio, phenyl or halogen such as fluorine, chlorine, bromine and iodine.

The granular additive or the detergent composition may comprise an anti-corrosion agent in an amount of from 0.01% by weight to 5% by weight, 0.05% by weight to 3% by weight, 0.1% by weight to 2.5% by weight, or 0.2% by weight to 2% by weight, based on the total weight.

### Polymer

The granular additive or the detergent composition may comprise one or more polymer(s) in addition to the cationic polymer of the present invention. Beneficially, one or more polymer(s) may improve the cleaning performance of the detergent composition. The polymer may be a sulphonated polymer. The polymer may be a copolymer. The copolymer may be a copolymer of

CH₂═CR¹—CR²R³—O—C₄H₃R⁴—SO₃X

where R¹, R², R³ and R⁴ are independently 1 to 6 carbon alkyl or hydrogen, and X is hydrogen or alkali with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene, or mixtures thereof.
The (co)polymer may include sulphonated monomer units, for example 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenylow)propanesulphonic acid, 2-methyl-2-propenen-1-sulphonic acid, styrenesulphonic acid, vinylsulphonic acid, 3-sulphopropyl acrylate, 3-sulphopropylmethacrylate, sulphomethylacrylamide, sulphomethylmethacrylamide and water soluble salts thereof, or mixtures thereof.

The granular additive or the detergent composition may comprise a sulphonated polymer in an amount of at least 0.1% by weight, at least 0.5% by weight, at least 1% by weight, at least 3% by weight, or up to 40% by weight, up to 25% by weight, up to 15% by weight, or up to 10% by weight.

Foam control agent

The granular additive or the detergent composition may comprise one or more foam control agent(s). The one or more foam control agent(s) may be any conventionally used in this field, for example silicones and their derivatives, or paraffin oil, or mixtures thereof. The foam control agent may be present in an amount of 0.5% by weight or less.

### Preservative

The granular additive or the detergent composition may comprise minor, conventional, amounts of one or more preservative(s).

### Auxiliary

The granular additive or the detergent composition may comprise auxiliary ingredients like for example, fragrance, dye, etc.

### EXAMPLES

### Example 1—Manufacture of Granular Additive

Example 1 was carried out using a cationic polymer having a pH-independent permanent positive charge having the following structure (Compound 1)):

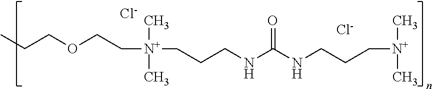

Compound 1 had a pH-independent permanent positive charge having a permanent charge density of 5.31 meq/g.

Two compositions, Granular Additive 1 and Granular Additive 2, were prepared according to the following formulations:

| | Granular Additive No. 1 | Granular Additive No. 2 |
|---|---|---|
| MGDA (kg) | 28.54 | 26.99 |
| Silicate (kg) | 0 | 1.57 |
| Compound 1 (kg of | 0.029 | 0.027 |
| solid portion of | | |
| aqueous solution) | | |

The silicate was Britesil H2O Hydrous Sodium Silicate which comprised approximately 82.5% wt. sodium silicate and approximately 17.5% wt. water.

MGDA and silicate were each in the form of a solid.

Compound 1 was in the form of an aqueous solution comprising 62 wt. % solids in water.

The respective amounts of MGDA, silicate and Compound 1 were mixed.

Each mixture was blended with water to form a slurry. The water was present in an amount such that each mixture comprised 60% solids.

Each slurry was then heated to 80° C. and spray-dried in a co-current spray-drying tower using an air inlet temperature of 220° C. and an air outlet temperature of 110° C. to provide amorphous solid spray-dried particles having a moisture content of 10.3% by weight based on chemical analysis. A rotating disc atomizer was used for slurry droplet formation in the spray-dryer, using an atomising air pressure of 6 bar and an atomising airflow of 65%. The spray-dried particles had the following compositions:

| | Granular | Granular | Comparative |
|---|---|---|---|
| | Additive | Additive | Granular |
| | No. 1 | No. 2 | Additive |
| MGDA (% by | 89.61 | 84.70 | 84.70 |
| weight) | | | |
| Silicate (% by | 0 | 4.92 | 5.00 |
| weight) | | | |
| Compound 1 (% by | 0.09 | 0.08 | 0 |
| weight) | | | |
| Water (% by | 10.3 | 10.3 | 10.3 |
| weight) | | | |

A conventional granular additive composition (Comparative Granular Additive) was also prepared. The Comparative Granular Additive was in the form of spray-dried particles having a composition as shown above. The Comparative Granular Additive did not comprise any Compound 1.

The spray-dried particles were compacted into compacted aggregates (using a roller compactor having two rollers with a 4 mm nip gap into which the spray-dried particles were fed using a twin-screw feed, then compacted into a sheet) using a compaction pressure between 110 and 120 bar, and then comminuted and classified by sieving using a 500 μm sieve and a 1000 μm sieve.

### Example 2—Shine Performance

Two detergent compositions, Comparative Composition (1) and Inventive Composition (1), were prepared as follows:

| | | Comparative | Inventive |
|---|---|---|---|
| | | Composition (1) | Composition (1) |
| Function | Raw Materials | g/wash | g/wash |
| Builder | Trisodium citrate | 2.23 | 2.23 |
| System | Comparative Granular | 2.00 | — |
| | Additive | | |
| | Compound 1 | 0.002 | — |
| | Solvents | 0.006 | — |
| | Granular Additive | — | 2.00 |
| | No. 2 | | |
| | HEDP | 0.85 | 0.85 |
| Alkali | Sodium carbonate | 1.33 | 1.33 |
| Bleach | Sodium percarbonate | 1.85 | 1.85 |
| System | Bleach activators, | 0.85 | 0.85 |
| | Bleach catalyst | | |
| Polymers | Copolymer AA/AMPS | 0.62 | 0.62 |
| | Copolymer MA/AA | 0.10 | 0.10 |
| Enzymes | Protease | 0.41 | 0.41 |
| | Amylase | 0.10 | 0.10 |
| Surfactant | Alkoxylated fatty | 2.16 | 2.16 |
| | alcohol (EO/PO) | | |
| Others | Gel thickening agent | 0.52 | 0.52 |
| | Silver protection agent | 0.03 | 0.03 |
| | Antifoaming agent | 0.01 | 0.01 |
| | Fragrance | 0.04 | 0.04 |
| | Blue colorant | 0.004 | 0.004 |
| | Red colorant | 0.001 | 0.001 |
| | Water-soluble film | 0.59 | 0.59 |

Inventive Composition (1) comprised Compound 1 in the form of Granular Additive No. 2. The amount of Compound 1 in Inventive Composition (1) was 0.0016 g/wash.

Each Composition was contained in a separate PVOH film capsule. Each PVOH film capsule was a three-compartment capsule comprising a liquid component in a first compartment, a gel component in a second compartment and a solid (powder) component in a third compartment.

| Machine Type | Miele G 1222 SC GSL | | |
|---|---|---|---|
| Program | 65° C./65° C. | | |
| Water | <1° GH (KW) | | |
| Hardness | | | |
| Evaluation | after 25 washing cycles, two trained evaluators | | |
| | | Comparative | Inventive |
| | Parameter | Composition (1) | Composition (1) |
| | Glass Clouding | 2.9 | 3.1 |
| | Cordlines | 4.3 | 4.2 |
| | Sum of Mass | 100 | 114 |
| | Loss Glass [mg] | | |

In each test, a glass test article was placed inside the dishwasher before the start of the dishwashing cycle.

Scoring:
5═No discolouration or shine loss
4=Minor discolouration or shine loss
3=Discolouration or shine loss visible
2=Strong discolouration or shine loss
1=Very strong discolouration or shine loss

A difference of <0.5 score on Glass Clouding and Cordlines is not considered distinctive. Each test product was visually examined.

It is notable and surprising that Inventive Composition (1), comprising Compound (1)in the form of Granular Additive No. 2, exhibits no significant difference in shine performance and mass loss compared to Comparative Composition (1) which comprised Compound 1 as an aqueous solution.

### Example 3—Material Care Performance

Example 3 was carried out using Comparative Composition (1) and Inventive Composition (1), each prepared as described above.

| Machine Type | Bosch | | |
|---|---|---|---|
| Program | Eco | | |
| Water | 21° GH | | |
| Hardness | | | |
| Evaluation | after 5 washing cycles, two trained evaluators | | |
| | | Comparative | Inventive |
| | Parameter | Composition (1) | Composition (1) |
| Short term | Glass spotting | 2.0 | 2.0 |
| shine (5 | Glass filming | 3.1 | 3.3 |
| cycles) | Cutlery spotting | 2.0 | 2.0 |
| | Cutlery Filming | 3.0 | 3.0 |

A difference of ≥0.5 on spotting is considered distinctive.
Scoring is as described above.

Notably, as can be observed in the table above, Inventive Composition (1), comprising Compound (1) in the form of Granular Additive No. 2, exhibits no significant difference in material care performance, such as filming and spotting, compared to Comparative Composition (1) which comprised Compound 1 as an aqueous solution. As such, favourable results can be obtained when using a granular additive according to the invention.

Thus, advantageously, it is notable and surprising that the results show Compound (1) can be supplied into a detergent composition (Inventive Composition (1)) as part of a granular additive, instead of as an aqueous solution as with conventional detergent compositions (Comparative Composition (1)) and still achieve comparable overall cleaning performance.

Favourably, this indicates that a detergent composition comprising a granular additive according to the invention presents substantial benefits compared to conventional detergent compositions, for example, an increased stability of the ingredients comprised in the detergent composition, elimination, or at least a significant reduction of, ‘powder clumping’, reduced environmental impact and greater distribution of the active component, i.e., Compound 1, across the final consumer product.

Further, Inventive Composition (1) comprises fewer ingredients than Comparative Composition (1) such that manufacture of Inventive Composition (1) is comparably less complex than manufacture of Comparative Composition (1). In particular, as shown in the table above, Inventive Composition (1) does not require the use of a solvent. A solvent is used when manufacturing Comparative Composition (1) to provide its ingredients in a processable form, typically by way of a pre-mix composition comprising the active component. Advantageously, Inventive Composition (1), comprising Compound 1 in the form of a granular additive, is manufactured without a solvent, therefore, avoiding undesirable side-reactions which may occur between the solvent and the active component (i.e., Compound 1), or other detergent ingredients, which may reduce the effectiveness of the active component.

As such, a detergent composition comprising Compound 1 in the form of a granular additive provides a reliable and effective delivery of benefits (for example, shine performance and material care performance) and simultaneously ameliorates the disadvantages associated with conventional detergent compositions comprising active components in the form of an aqueous solution.

The above embodiments are described by way of example only. Many variations are possible without departing from the scope of the invention as defined in the appended claims.

1. A granular additive for a detergent composition, the granular additive comprising at least one builder and at least one cationic polymer, wherein the cationic polymer has a pH-independent permanent positive charge.

2. A granular additive according to claim 1, wherein the cationic polymer comprises at least one quaternary ammonium group.

3. A granular additive according to claim 2, wherein the at least one quaternary ammonium group is selected from alkylammonium, dialkylammonium, trialkylammonium, iminium, amidinium, formamidinium, guanidinium and biguanidinium quaternary ammonium groups.

4. A granular additive according to claim 2 or 3, wherein the at least one quaternary ammonium group has the formula:
—⁺N(R¹)(R²)—
wherein R¹ and R² are each independently selected from a hydrogen atom, an alkyl group, an aryl group, a heteroaryl group, a cycloalkyl group, a heterocycloalkyl group, an alkoxy group, an aryloxy group, an alcohol group, a carboxylate ester group and an ether group.

5. A granular additive according to claim 4, wherein at least one of R¹ and R² is a linear or branched C1 to C10 alkyl group; wherein preferably at least one of R¹ and R² is a linear C1 to C3 alkyl group; wherein more preferably R¹ and R² are each a linear C1 to C3 alkyl group, and wherein most preferably R¹ and R² are each a methyl group.

6. A granular additive according to any of claims 2 to 5, wherein the degree of quaternization of the cationic polymer may be between about 1 and about 100 mol %, between about 10 and about 90 mol %, between about 20 and about 80 mol %, between about 30 and about 70 mol %, between about 40 and about 60 mol %, or about 50 mol %, based on quaternizable N-atoms in the cationic polymer.

7. A granular additive according to any preceding claim, wherein the cationic polymer further comprises a urea group and/or a urethane group, or a thio-derivative thereof: wherein preferably the cationic polymer is a polyurethane cationic polymer.

8. A granular additive according to any preceding claim, wherein the cationic polymer has a pH-independent permanent positive charge having a permanent charge density of at least about 3 meq/g, preferably between about 3 and about 8 meq/g.

9. A granular additive according to any preceding claim, wherein the cationic polymer is present in an amount between about 0.01 and about 5% wt., preferably about 0.1% wt., based on the weight of the granular additive.

10. A granular additive according to any preceding claim, wherein the builder is selected from the group comprising hydroxycarboxylates, aminocarboxylates, dicarboxylic acid amines and/or phosphates, or the salts thereof, or mixtures thereof: wherein preferably the builder is selected from the group comprising methylglycinediacetic acid (MGDA), glutamic acid N,N-diacetic acid (GLDA), iminodisuccinic acid (IDS) and trisodium citrate, or mixtures thereof.

11. A detergent composition comprising a granular additive of any preceding claim; wherein preferably the granular additive is present in an amount of between about 10 and about 500 mg per gram of detergent composition.

12. A package or device containing a granular additive or a detergent composition according to any one of the preceding claims: wherein preferably the package or device is a multi-compartment container, and wherein preferably the granular additive or detergent composition is located in at least one compartment; and wherein more preferably the at least one compartment comprising the granular additive or detergent composition further comprises a solid composition comprising one or more cleaning actives, or a liquid composition comprising one or more cleaning actives, or a gel composition comprising one or more cleaning actives.

13. Use of a granular additive according to any of claims 1 to 10 or a detergent composition according to claim 11 or a package or device according to claim 12 for treating or washing soiled kitchenware; or for domestic cleaning or treatment, including automatic dishwashing, hard surface cleaning, water treatment and laundry washing.

14. A method of treating or washing kitchenware in a dishwashing machine, wherein a granular additive according to any of claims 1 to 10 or a detergent composition according to claim 11 or a package or device according to claim 12 is added to the dishwashing machine: wherein preferably the method of treatment is a method of preventing or reducing corrosion of glass.

15. A method for preparing a granular additive according to any of claims 1 to 10, the method comprising the steps of:
a. mixing a builder with a cationic polymer, wherein the cationic polymer has a pH-independent permanent positive charge.
